(19) United States
(12) Patent Application Publication
(10) Pub. No.: US 2008/0022275 A1
(43) Pub. Date: Jan. 24, 2008

(54) Method for Installing a Software Program on a Computer

(75) Inventor: Christoph Herrmann, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,791

(22) PCT Filed: Sep. 21, 2005
(86) PCT No.: PCT/IB05/53105

§ 371 Date: Mar. 22, 2007

(30) Foreign Application Priority Data
Sep. 29, 2004 (EP) 04104774.7

(51) Int. Cl. G06F 9/445

(52) U.S. Cl. 717/175

(57) ABSTRACT

To provide a method and system allowing an easy and user adapted installation of a software program on a computer it is proposed to store (24) changes of configuration files and/or addendum files within a predetermined folder. These configuration and/or addendum files are used for executing the software program. Further these configuration and/or addendum files of the software program are stored (30) on the installation medium also. This provides a simple solution for re-installing a software program on a new computer. In particular this solution is independently of the state of the old computer, since the current configuration and/or addendum files are present at the installation medium also. In case of a system crash the user is able to use the installation medium including the current configuration and/or addendum files. So the user saves its individual settings of a software program systematically.

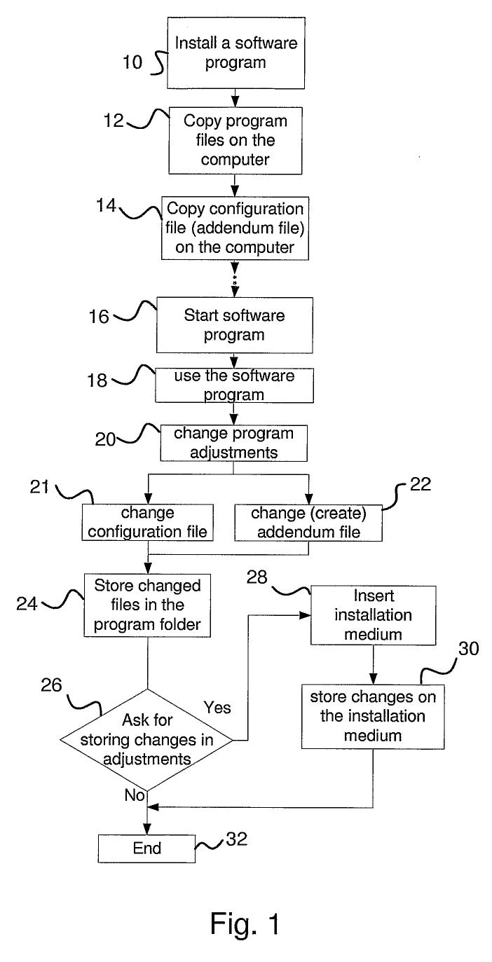

The invention relates to a method for installing a software program on a computer. It further relates to a system for installing a software program.

A computer includes a lot of software programs stored on a hard disk. Most software programs provide the possibility to individually adjust the software program according to the intention and requirements of the user.

To adjust a software program several parameters or options are set. The adjustments relate to a plurality of options, e.g. the kind of displaying the program, the place and period of storing program files, user files etc. Mostly the adjustments are made within a long period of time suddenly and separately. So the process of adjusting a software program is performed successively and not systematically. Mostly the user does not remember the certain adjustments.

During the time working with a computer a lot of software programs are installed on the computer. Each program is installed individually by the user. Especially the program options are set depending on the user.

Normally an installation routine performs the installation process of the program files. Assumed a base configuration of the computer is not changed the program files are stored at the same place on a hard disk automatically. The configurations and adjustments made by the user during the use of the software program are stored in configuration files mostly stored in the same program folder or another folder defined by the manufacturer.

Beside the adjustments of options for a software program several addendums are made by the user. In particular the personal dictionaries are expanded. Some software programs use personal styles, shapes and templates. These addendum files are stored also in the program folder of the respective software program or in a particular folder, which the manufacturer of the software program defines.

The increase of processing speed, graphical performance and storing capacities results in a regular exchange of hardware. It is possible to replace single parts of the computer, wherein the problem of a re-installation could be avoided very seldom.

For re-installing a computer, e.g. due to a new hardware construction (the computer might need a larger hard drive), due to a migration to a new operating system or due to a system crash e.g. because of hardware malfunctioning or due to infection by a virus, it is necessary to install the operating system and all individual software programs again on the new computer. Sometimes the old computer could be used to restore configuration and addendum files. So a re-installation of the software program on the new computer is possible, based on the old configuration and addendum files. However this implies that the user knows the place of storing of the configuration and addendum files within the folder structure of the old computer.

In case of a system crash all configuration—and addendum files are lost definitively.

The search for configuration and addendum files on the old computer represents a time consuming burden for the user. In many cases, he does not even know the name of the configuration file for a particular program; if the configuration or addendum data is not stored in a text file, which can be viewed with a normal text editor, it is usually impossible for the user to find the configuration and addendum file.

The loss of configuration and addendum files requires a time consuming re-adjustment of options. Individual addendums of dictionaries etc. are lost. This may require a new creation of personal dictionaries. A spelling check of technical terms without the personal dictionary is very time consuming. A further disadvantage could appear if a user relies on the old configuration files. If an automatically storing was set in the old configuration on the crashed system and if the automatic storing function in the new configuration of the software program on the newly installed system is not set a loss of files and a loss of valuable working hours could appear.

The US 2002/0026572 A1 describes how to access and use setup data from a source computer and to replace setup data from a destination application or computer. The replaced setup data may be preserved for reinstatement of future access. It is used to provide the same look of software programs to the user if the user accesses a software program from different computers. It does not address the problem of how to preserve changed configuration files and addendum files of programs, when the software program has to be re-installed.

Therefore it is an object of the invention to provide a method and system allowing an easy and user adapted installation of a software program on a computer.

This object is solved by the features given in the independent claims.

The invention is based on the thought that a configuration file and/or addendum file including adjustments made by the user should be placed on the installation medium at a predetermined time. If the archiving of the changes of the configuration file and/or addendum file is not performed at this predetermined time, problems could arise during a re-installation of a software program as described above.

The object is solved by a method for installing a software program on a computer comprising the steps of: storing a program file of the software program in a program folder from an installation medium; storing a configuration file and/or addendum file of the software program in a predetermined program folder; storing changes of the configuration file and/or addendum file in the predetermined folder, providing the installation medium for storing changes of the configuration file and/or addendum file, storing changes of the configuration file and/or addendum file on the installation medium.

The inventive method ensures that the changes of the configuration file and/or addendum file are stored directly in the predetermined folder of the software program and on the installation medium also. The configuration file and/or addendum file stored in the predetermined folder could be lost during a system crash. Then the user needs to re-install the respective software program. For re-installing a software program the installation medium is used. If the current (i.e. changed) configuration file and/or addendum file are stored on this installation medium also, e.g. with an indication of the particular user in the file name of the configuration and addendum file, or in a specific folder relating to a particular user, the user will have access to the configuration file and/or addendum file independently of the usability of the old computer. Since the user normally does not notice any change in the configuration and addendum file he is not aware of the problem. He will not recognize this problem until he has re-installed the corresponding software program and, when using the re-installed software program, notices the changed look and behavior of the software program. Since he does not notice the changes he omits to save the changes on a separate medium. The inventive method urges the user to save the changes. Saving the changes of the configuration file and/or addendum file on the installation medium provides the advantage that all necessary files, the program file and the current individual configuration and/or addendum files are stored together on one medium.

If the changes of the configuration and addendum files are stored at a predetermined time the problems mentioned above are removed. By using the inventive method all changes of the configuration and addendum file made during the time of use of a software program are saved and could be used for a re-installation. They could be used for re-installation independently of the reason for re-installation. It is further possible to use the continuously updated configuration and addendum files for further installations of the software program on notebooks or other computer devices, if the license clause allows a multiple installation. Otherwise only the configuration and addendum files could be used. Thus the user is able to work with the software program having a familiar look and behavior.

In a preferred embodiment of the invention it is advantageous to store the changes directly at the time the changes are made. Therefore the user is prompted by the computer system to provide the installation medium. Providing the installation medium means inserting a disk or memory stick or indicating a path of an installation folder. It is also possible to schedule the storing of changes at a predetermined time. So the user is not interrupted in his daily work. However changes made between the last storing time and a system crash are not saved. But the risk to loose all adjustments and chances is minimized.

In a further preferred embodiment there is a part of the installation medium, which is writeable, wherein the program files are stored on a none writeable medium. For software programs having a small size the problem could easily be solved by using a floppy disk. Since most installation programs are stored on CDs or DVDs it is possible to store the installation program on a rewriteable disk. So the changes of the configuration file could be stored on the rewriteable disk also. A further possibility is to use a floppy disk or other writeable medium put together with the installation medium. The changes of the configuration and addendum files are stored on the floppy disk or other writeable medium. Then the installation routine needs to prompt the user to insert the floppy disk or other writeable medium to copy and store the configuration and addendum file in the predetermined folder of the computer. During installation of the software program the installation routine needs to access the configuration and/or addendum file stored on the floppy disk or other writeable medium to copy the current configuration and/or addendum files into the predetermined folder.

It is advantageous to use the program folder as predetermined folder for storing the changes. So the configuration and/or addendum file are stored together with the program files in the same folder. However another folder defined by the manufacturer of the software program could be used also for storing changes of configuration and/or addendum files. This will apply if several software programs are adjusted for different users. So the configuration and/or addendum files of several users will be stored in user depending folders.

A further possibility is to use a network drive as installation medium. So the software program can automatically store the changes of the configuration and/or addendum file on the network drive as long as the computer is connected to the network. So a user can re-install the software program easily after having connected the new computer to the network. Furthermore, he has access to his individual configuration and/or addendum file or files if he works on a different computer station. The embodiment allows the storing of changes in the background without prompting the user to insert the installation medium. If the user has activated an automatically storing function in a program setup the program will store the changes automatically without interaction of the user.

An addendum file includes personal dictionaries, styles, shapes, templates etc. In particular the creation of a dictionary or a plurality of templates is very time consuming. So a loss would be very awkward. The inventive method proposes to store the addendum files together with the configuration file or separately on the installation medium.

If changes are made in the configuration and/or addendum files it is advantageous to start a routine for asking the user if he wants to store the changes. The asking may be performed by displaying a separate window. If the user wants to store the changes he is requested to insert the installation medium. If the medium is coupled via a network the user should indicate the path of the installation folder including the program files and the configuration and addendum files. After having specified the path or inserted the installation medium in a writing device, like a CD or DVD writer or a floppy drive the changes are stored on the installation medium.

In a preferred embodiment the most recent configuration files or addendum files are used for storing in the program folder or the folder defined by the manufacturer of the software program to contain configuration files or addendum files. At the very first installation the configuration and or addendum file may be empty or include only default adjustments. After having used the software program the configuration and/or addendum file is changed, wherein the basic configuration and/or addendum file on the installation medium is not overwritten. A new, more recent configuration and/or addendum file is created on the installation medium, and it may be saved under a name, which identifies the user, who uses this file. During re-installing the installation routine searches for the latest version of configuration and/or addendum files, or it may prompt the user to select his particular configuration and/or addendum file. If the configuration and/or addendum file contains confidential information, it may be necessary to apply access rights so that only the user who actually used this configuration and/or addendum file can later on use it in a (re-)installation procedure.

In a further preferred embodiment there is an option in the program setup enabling to activate/deactivate the information of changes of the configuration and/or addendum files. So the user can deactivate this function.

It is further preferred to store changes of the configurations file and/or addendum file on a configuration medium. This configuration medium is part of the installation medium. The configuration medium could be a physical part of the installation medium or a separate physical medium belonging to the installation medium. In other words, the part of the configuration medium containing the current configuration and/or addendum files belongs to a certain installation medium of a first software program, wherein another part of the configuration medium containing another configuration and/or addendum file belongs to another installation medium of a second software program. Since several software programs are stored on a computer it is inconvenient to insert different installation media very often. So the use of a configuration medium could solve this problem. The changes of configuration files and/or addendum files of several software programs are stored on a common configuration medium. The configuration medium may be permanently available in the computer, so that it does not have to be inserted when changes of configuration files and/or addendum files occur and are to be stored. During re-installation of a software program the installation routine is prompting the user to specify the path of the respective configuration file/addendum file for the software program. So the user has to insert the common configuration medium, unless it is already available within the computer and to specify the respective path associated to the respective software program.

The object will also be solved by a computer program containing program code to carry out the steps of the method as described above when said program code is running on a computer and in the case that the program is stored on a data carrier.

The object will also be solved by a system for installing a software program comprising means to perform the steps of the method as described above.

These and other aspects of the invention will be apparent from and elucidated with reference to the embodiments described hereinafter.

The FIGURE shows a flow chart representing the method in detail according to the present invention.

In step 10 the procedure is started with the installation of a software program. An installation routine copies the program files into a program folder of a hard disk of the computer (step 12). Also the configuration file is copied and stored in the program folder of the hard disk (step 14) from the installation medium. In case of a re-installation also the addendum file is copied on the hard disk of the computer in the program folder. The software program is started in step 16. This could be done directly after having installed the software program or if the software program should be used the first time. Then the software program will be used. During the use of the software program (step 18) the user is setting up or adjusting the options of the software program (step 20). For example a look of a program window is adjusted (colors, backgrounds) etc. Also paths for storing of user files and dictionary files could be set (step 21). Additionally changes or extensions of a dictionary, i.e. additional entries with new words and their translation or further translations of a word already available in the dictionary, of templates etc. are stored in an addendum file (step 22). All these changes are stored at first at the place within the program folder or in the folder defined by the manufacturer of the software program to contain such files on the hard disk of the computer. These versions of the configuration file or addendum file are used during the execution of the software program. There may be more than one configuration file or addendum file. According to the invention the changes are also stored on the installation medium (step 30).

In an embodiment of the invention the user will be asked whether he wants to store the changes (step 26). If the user decides to store the changes he is prompted to provide the installation medium (step 28). After storing the changes on the installation the procedure is finished (step 32).

In an alternative embodiment of the invention (not illustrated) the installation medium is provided on a network drive coupled to the computer. This solution may be applied for a group of computers connected via a network. In this case the storing of changes could be performed in the background without interaction of the user. The user has to set the option of automatically storing of changes of the configuration file or addendum file on the installation medium only. This option could be set in the configuration of the program file.

In a further embodiment (not illustrated) the changes will be stored at predetermined points in time. If several software programs use the inventive method of storing the changes on the installation medium it could be inconvenient to insert different installation media permanently. The user would have to handle a lot of different installation media. To avoid this effort it is proposed to store the changes of configuration files and addendum files of a plurality of software programs together on one configuration medium, which may have different folders for the configuration files of different programs, and for different users, who may have access to the particular computer and can use the software programs. This configuration medium is used by the different installation routines for re-installing the respective software programs for copying the respective configuration or addendum files for the software program which should be installed. In this case the installation routine for installing the software program on the computer needs only to be changed in the names of the paths of the folders or locations, from where to copy the configuration or addendum files, since these files are placed on a configuration medium. In other words, a software program, that supports the proposed mechanism for preserving the updated configuration files and addendum files on a configuration medium, such that they are available in a later (re-)installation procedure, according to the present invention would foresee a step during the installation procedure, in which the user, who (re-)installs the software would be asked to enter a pathname or location, under which the configuration medium can be accessed and from where the updated configuration files or addendum files can be retrieved to be copied to the right folder or location, so that the installed software program can make use of the preserved updated configuration files or addendum files. Advantageously, during this step, by which the software program is installed including the updated configuration files and updated addendum files, the updated configuration files and updated addendum files are also stored on the installation medium, so that from then on their latest versions are also available on the installation medium. The configuration medium could be e.g. an area on the available hard drive (which however would be somewhat risky in case of a hard disk crash), a separate hard drive, a PCMCIA solid state memory (i.e. removable), a rewriteable CD, or the like.

By using the inventive method the loss of individual configuration and addendum data is prevented systematically. The adapted configuration and addendum data are available for a re-installation independently of the state of the old computer.

These embodiments have been described in an illustrative manner, and it is to be understood that the terminology which has been used is intended to be in the nature of words of description rather than of limitation. It is further to be understood that the terminology “comprising” does not exclude other elements or steps. One skilled in the art will readily recognize from such discussion, and from the accompanying drawings and claims, that changes and modifications can be made without departing from the scope of the invention as defined in the following claims, wherein reference signs shall not be construed as limiting the scope of claims.

1. Method for installing a software program on a computer comprising the steps of:
storing (12) a program file of the software program in a program folder from an installation medium;
storing a configuration file and/or addendum file (14) of the software program in a predetermined folder;
storing changes of the configuration file and/or addendum file in the predetermined folder (24);
providing (28) the installation medium for storing changes of the configuration file and/or addendum file,
storing (30) changes of the configuration file and/or addendum file on the installation medium.

2. Method as claimed in claim 1, wherein the changes of the configuration file and/or addendum file are stored at a time the changes are performed or after a predetermined period.

3. Method as claimed in claim 1, wherein the installation medium comprises a writeable part.

4. Method as claimed in claim 3, wherein the writeable part is a separate physical medium.

5. Method as claimed in claim 1, wherein the predetermined folder (24) is the program folder (24) or another folder defined for storing the configuration file.

6. Method as claimed in claim 1, wherein the installation medium is coupled with the computer via a network and the changes of the configuration file and/or addendum file are stored on the network coupled installation medium at a time the changes are performed.

7. Method as claimed in claim 1, the step of providing the installation medium further comprises:
starting a program routine;
asking (26) the user to decide to store changes of the configuration and/or addendum file on the installation medium;
after having decided to store the changes prompting to provide (28) the installation medium or indicate the place of the installation medium;
storing the changes (30) on the installation medium.

8. Method as claimed in claim 1, wherein changes of the configuration file and/or addendum file of at least one software program are stored on a configuration medium being part of the installation medium of the at least one software program.

9. Method as claimed in claim 1, further comprises:
setting an option within the software program for notifying the user of changes within the configuration and addendum files.

10. A computer program containing a program code to carry out the steps of the method of claim 1, when said program code is running on a computer.

11. A computer program containing a program code to carry out the steps of the method of claim 1, said program code being stored on a data carrier.

12. A system for installing a software program comprising means to perform the steps of the method as claimed in claim 1.

13. A device comprising a computer program containing a program code to carry out the steps of the method of claim 1 when said program is running on the device.
